(19) United States
(12) Patent Application Publication
(10) Pub. No.: US 2008/0237356 A1
(43) Pub. Date: Oct. 2, 2008

(54) STEP CARD AND METHOD FOR MAKING A STEP CARD

(75) Inventors: ROBERT SINGLETON, Lakeland, FL (US); Paul MEYER, Lakeland, FL (US)

Correspondence Address: FOLEY AND LARDNER LLP;SUITE 500, 3000 K STREET NW, WASHINGTON, DC, 20007, US

(73) Assignee: INNOVATIER, INC.

(21) Appl. No.: 12/052,803

(22) Filed: Mar. 21, 2008

Related U.S. Application Data
(60) Provisional application No. 60/896,658, filed on Mar. 23, 2007.

(51) Int. Cl. G06K 19/067

(52) U.S. Cl. 235/492; 29/825

(57) ABSTRACT

An electronic card and a method for manufacturing the same wherein the electronic card is composed of a printed circuit board, having a top surface and a bottom surface, a plurality of circuit components attached to the top surface of the printed circuit board, wherein the circuit components positioned in a first portion of the electronic card are greater in height than the circuit components positioned in a second portion of the electronic card, a bottom overlay attached to the bottom surface of the printed circuit board, a top overlay positioned above the top surface of the printed circuit board and a core layer positioned between the top surface of the printed circuit board and the top overlay, wherein the first portion of the electronic card has a greater thickness than the second portion of the electronic card.

This regular U.S. utility application claims priority to U.S. Provisional Application Ser. No. 60/896,658, which was filed on Mar. 23, 2007, and which is incorporated herein by reference in its entirety.

### FIELD OF INVENTION

### Background

The present invention relates generally to the field of electronic devices and, more particularly, to the field of electronic cards with embedded powered circuits and the method of making such electronic cards.

The following description of the background of the invention is provided simply as an aid in understanding the invention and is not admitted to describe or constitute prior art to the invention.

Generally, electronic devices can be encapsulated in various materials and used for applications such as smart cards or tags. Smart cards/tags may be used as credit cards, bankcards, ID cards, telephone cards, security cards or similar devices. Smart cards/tags are generally constructed by assembling several layers of plastic sheets in a sandwich array. Further, smart cards/tags contain embedded electronic components that enable the smart card to perform a number of functions.

European Patent 0 350 179 discloses a smart card wherein electronic circuitry is encapsulated in a layer of plastic material that is introduced between the card's two surface layers. The method further comprises abutting a high tensile strength holding member against a side of a mould, locating the smart card's electronic components with respect to that side and then injecting a reaction moldable polymeric material into the mould such that it encapsulates the electronic components.

European Patent Application 95400365.3 teaches a method for making contact-less smart cards. The method employs a rigid frame to position and fix an electronic module in a void space between an upper thermoplastic sheet and a lower thermoplastic sheet. After the frame is mechanically affixed to the lower thermoplastic sheet, the void space is filled with a polymerizable resin material.

U.S. Pat. No. 5,399,847 teaches a credit card that is comprised of three layers, namely, a first outer layer, a second outer layer and an intermediate layer. The intermediate layer is formed by injection of a thermoplastic binding material that encases the smart card's electronic elements (e.g., an IC chip and an antenna) in the intermediate layer material. The binding material is preferably made up of a blend of copolyamides or a glue having two or more chemically reactive components that harden upon contact with air. The outer layers of this smart card can be made up of various polymeric materials such as polyvinyl chloride or polyurethane.

U.S. Pat. No. 5,417,905 teaches a method for manufacturing plastic credit cards wherein a mold tool comprised of two shells is closed to define a cavity for producing such cards. A label or image support is placed in each mold shell. The mold shells are then brought together and a thermoplastic material injected into the mold to form the card. The inflowing plastic forces the labels or image supports against the respective mold faces.

U.S. Pat. No. 5,510,074 teaches a method of manufacturing smart cards having a card body with substantially parallel major sides, a support member with a graphic element on at least one side, and an electronic module comprising a contact array that is fixed to a chip. The manufacturing method generally comprises the steps of: (1) placing the support member in a mold that defines the volume and shape of the card; (2) holding the support member against a first main wall of the mold; (3) injecting a thermoplastic material into the volume defined by the hollow space in order to fill that portion of the volume that is not occupied by the support member; and (4) inserting an electronic module at an appropriate position in the thermoplastic material before the injected material has the opportunity to completely solidify.

U.S. Pat. No. 4,339,407 discloses an electronic circuit encapsulation device in the form of a carrier having walls that have a specific arrangement of lands, grooves and bosses in combination with specific orifices. The mold's wall sections hold a circuit assembly in a given alignment. The walls of the carrier are made of a slightly flexible material in order to facilitate insertion of the smart card's electronic circuitry. The carrier is capable of being inserted into an outer mold. This causes the carrier walls to move toward one another in order to hold the components securely in alignment during the injection of the thermoplastic material. The outside of the walls of the carrier has projections that serve to mate with detents on the walls of the mold in order to locate and fix the carrier within the mold. The mold also has holes to permit the escape of trapped gases.

U.S. Pat. No. 5,350,553 teaches a method of producing a decorative pattern on, and placing an electronic circuit in, a plastic card in an injection molding machine. The method comprises the steps of: (a) introducing and positioning a film (e.g., a film bearing a decorative pattern), over an open mold cavity in the injection molding machine; (b) closing the mold cavity so that the film is fixed and clamped in position therein; (c) inserting an electronic circuit chip through an aperture in the mold into the mold cavity in order to position the chip in the cavity; (d) injecting a thermoplastic support composition into the mold cavity to form a unified card; and (e) thereafter, removing any excess material, opening the mold cavity and removing the card.

U.S. Pat. No. 4,961,893 teaches a smart card whose main feature is a support element that supports an integrated circuit chip. The support element is used for positioning the chip inside a mold cavity. The card body is formed by injecting a plastic material into the cavity so that the chip is entirely embedded in the plastic material. In some embodiments, the edge regions of the support are clamped between the load bearing surfaces of the respective molds. The support element may be a film that is peeled off the finished card or it may be a sheet that remains as an integral part of the card. If the support element is a peel-off film, then any graphics elements contained therein are transferred and remain visible on the card. If the support element remains as an integral part of the card, then such graphics elements are formed on a face thereof and, hence, are visible to the card user.

U.S. Pat. No. 5,498,388 teaches a smart card device that includes a card board having a through opening. A semiconductor module is mounted onto this opening. A resin is injected into the opening so that a resin molding is formed under such condition that only an electrode terminal face for external connection of said semiconductor module is exposed. The card is completed by mounting a card board having a through opening onto a lower mold of two opposing molding dies, mounting a semiconductor module onto the opening of said card board, tightening an upper die that has a gate leading onto a lower die and injecting a resin into the opening via the gate.

U.S. Pat. No. 5,423,705 teaches a disc having a disc body made of a thermoplastic injection molded material and a laminate layer that is integrally joined to a disc body. The laminate layer includes an outer clear lamina and an inner white and opaque lamina. An imaging material is sandwiched between these lamina.

U.S. Pat. No. 6,025,054 discloses a method for constructing a smart card using low shrinkage glue to hold the electronic devices in place during the devices immersion in thermosetting material that becomes the core layer of the smart card. The method disclosed in U.S. Pat. No. 6,025,054 has considerable drawbacks. Primarily, the disclosed method produces warping and other undesirable physical defects caused by the curing of thermosetting material. Further, this method is suitable only for cards having one or two components, thus limiting its functionality. In addition, the method disclosed in U.S. Pat. No. 6,025,054 creates defects such as voids and air bubbles within a smart card because the geometric shapes of the electronic components within the card obstruct the flow of the thermosetting material such that the thermosetting material flows around the components faster than the air can be pushed out of the core of the smart card. Moreover, U.S. Patent '054 requires the use of custom equipment, significantly limiting the scope and scalability of its application.

Generally, electronic devices such as electronic cards are designed to conform with known industry standards as well aesthetic appearance standards. For example, most if not all electronic cards are designed to be thin and uniformly flat in shape. The shape of these cards requires that any power source embedded in the card also have a small footprint. These smaller power sources have a limited power capacity which in turn limits the life span of the electronic card. Moreover, the types of slimmer power sources available is small in number, which considerably reduces design choices for manufacturers. Accordingly, the above mentioned limitations restrict more power intensive applications from being introduced in the electronic card market place. In view of the following, there is a need for a device and a method of constructing an electronic card that is capable of housing a number of powered electrical components without significantly increasing the size of the electronic card and its aesthetic design.

### SUMMARY

According to one embodiment, an electronic card includes a printed circuit board, having a top surface and a bottom surface; a plurality of circuit components attached to the top surface of the printed circuit board, wherein the circuit components positioned in a first portion of the electronic card are greater in height than the circuit components positioned in a second portion of the electronic card; a bottom overlay attached to the bottom surface of the printed circuit board; a top overlay positioned above the top surface of the printed circuit board; and a core layer positioned between the top surface of the printed circuit board and the top overlay, wherein the first portion of the electronic card has a greater thickness than the second portion of the electronic card.

According to another embodiment, a method for manufacturing an electronic card includes the steps of providing a printed circuit board having a top surface and a bottom surface; affixing a plurality of circuit components onto the top surface of the printed circuit board, wherein the circuit components positioned in a first portion of the electronic card are greater in height than the circuit components positioned in a second portion of the electronic card; affixing the bottom surface of the printed circuit board to a bottom overlay using a pressure sensitive adhesive tape or a spray-on adhesive; loading the printed circuit board and bottom overlay into an injection molding apparatus; loading a top overlay positioned above a top surface of the printed circuit board into the injection molding apparatus; injecting thermosetting polymeric material between the top surface of the printed circuit board, the plurality of circuit components and the top overlay such that the first portion of the electronic card has a greater thickness than the second portion of the electronic card.

### BRIEF DESCRIPTION OF THE DRAWINGS

These and other features, aspects and advantages of the present invention will become apparent from the following description, appended claims, and the accompanying exemplary embodiments shown in the drawings, which are briefly described below.

FIG. 1 is a sectional view of an electronic card according to one embodiment of the present invention.

FIG. 2 is a top sectional view of an electronic card according to one embodiment of the present invention.

FIG. 3 is a sectional view of an electronic card and an injection nozzle according to one embodiment of the present invention.

FIG. 4 is a top sectional view of a series of electronic cards formed on one molded sheet according to one embodiment of the present invention.

### DETAILED DESCRIPTION

Embodiments of the present invention will be described below with reference to the accompanying drawings. It should be understood that the following description is intended to describe exemplary embodiments of the invention, and not to limit the invention.

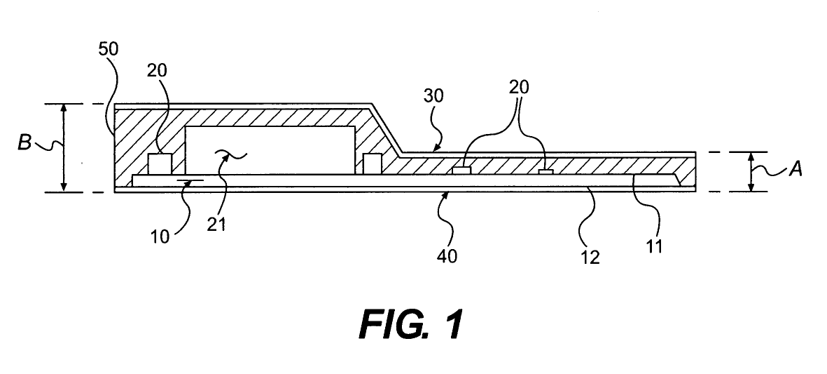

According to one embodiment of the present invention, as shown in FIG. 1, an electronic card 1 comprises a printed circuit board 10, a plurality of circuit components 20, a power source such as a battery 21, a bottom overlay 30, a top overlay 40 and a core layer 50. The electronic card 1 has at least two portions of different thicknesses. The battery 21 is positioned in a first portion of the electronic card 1 having a thickness B. A second portion of the electronic card 1 has a thickness A. As shown in FIG. 1, the first portion (encapsulating the battery) has a greater thickness (B>A) than the second portion. The electronic card 1 may be used in such applications as smart cards, tags and/or wristbands.

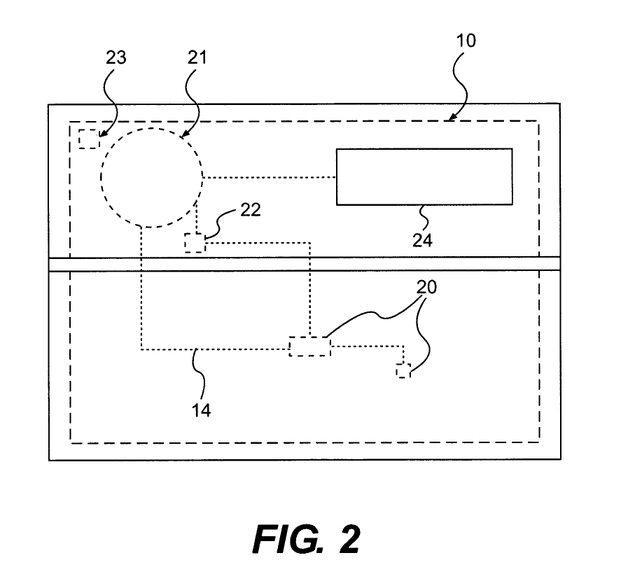

The printed circuit board 10 has a top surface 11 and a bottom surface 12. According to one embodiment of the invention, the printed circuit board 10 is double-sided. Accordingly, the printed circuit board 10 is configured to accommodate a plurality of circuit traces 14 (shown in FIG. 2) on the top surface 11 and on the bottom surface 12. The circuit traces 14 are configured to operably connect the plurality of circuit components 20 affixed to the printed circuit board 10. The circuit traces 14 electrically connect to the plurality of circuit components 20 such that the circuit components are capable of performing electrical functions within the electronic card 1.

The circuit traces 14 may be provided upon the surfaces 11, 12 of the printed circuit board in numerous ways. For example, the circuit traces 14 may be formed on the printed circuit board 10 with conductive ink. In the alternative, circuit traces 14 may be etched onto the printed circuit board.

The printed circuit board 10 is comprised of any known conventional material suitable for receiving an electronic circuit. For example, the printed circuit board 10 may be comprised of a flame retardant laminate with a woven glass reinforced epoxy resin. This material is also known as FR-4 board. Alternatively, the printed circuit board 10 may be comprised of a plastic compound that is suitable for receiving conductive ink.

As shown in FIG. 1, and described below, the printed circuit board 10 is configured to receive and vertically stabilize a plurality of circuit components 20. The plurality of circuit components 20 may be attached to the printed circuit board 10 and specifically to the circuit traces 14 by any one of a number of methods. For example, in one embodiment of the invention, the circuit components 20 are connected to the printed circuit board 10 with a conductive adhesive. Preferably, the plurality of circuit components are soldered onto the printed circuit board 10. The plurality of circuit components 20 can be positioned anywhere on the printed circuit board 10 as desired. The purpose of the electronic card 1 and design parameters will dictate the position of the circuit traces 14 and the position of the circuit components 20. Functionality will also dictate what types of circuit components 20 populate the printed circuit board 10.

For example purposes only, the plurality of circuit components 20 could be one of a battery, a button, a microprocessor chip or a speaker. Any one or all of these circuit components could populate the printed circuit board 10 along any portion of the electronic card. Further, additional circuit components 20 may include but are not limited to LEDs, flexible displays, RFID antennas and emulators. Referring to FIG. 2, a circuit layout for an electronic card 1 is shown. The printed circuit board 10 shown in FIG. 2 is populated by a battery 21, a microprocessor 22 and a button 23. In another embodiment of the present invention as shown in FIG. 2, the electronic card 1 includes a liquid crystal display 24 as the circuit component 20 connected to the button 23. The liquid crystal display 24 may be used to display information to a user, such as an account balance. In the alternative or in addition to, the embedded electronic card 1 shown in FIG. 2 may include a speaker (not shown).

Generally, the components shown in FIGS. 1 and 2 may vary in thickness and length. For example, the electronic card 1 can have an overall thickness of less than 0.09 inches. A first portion of the electronic card can have a thickness in the range of 0.030 to 0.090 inches. The thickness of the first portion of the electronic card allows for larger, taller and more powerful power sources such as batteries 21 and to be used in the electronic card 1. A second portion of the card can have a thickness of 0.030 inches or less. The variation in thickness of the first portion and second portion allows a more powerful card to be used with conventional applications that were originally design for cards of a smaller thickness. Accordingly, these dimensions allow the electronic card 1 to be compatible with the conventional equipment. For example purposes only, the battery 21 can have a thickness of 0.016 inches, the push button 23 can have a thickness of 0.020 inches and the microprocessor 22 can have a thickness of 0.015 inches. In addition, the electronic card 1 shown in FIG. 2 can have a speaker (not shown) having a thickness of 0.010 inches.

As shown in FIG. 1, a bottom overlay 30 is attached to the bottom surface 12 of the printed circuit board 10. The bottom overlay 30 can be, for example, 0.001 to 0.002 inches thick. The bottom overlay 30 can be attached to the printed circuit board 10 by any number of known methods. Preferably, the bottom surface 12 is attached to the bottom overlay 30 using a pressure sensitive adhesive tape or a spray-on adhesive. The bottom overlay 30 may be comprised of any suitable material but preferably, the bottom overlay 30 is comprised of polyvinyl chloride (PVC), polyester, acrylonitrile-butadiene-styrene (ABS), polycarbonate, polyethylene terephthalate (PET), PETG, or any other suitable material.

According to one embodiment of the invention, the surface of the bottom overlay 30 in contact with the printed circuit board 10 has printed information. Alternatively, printed information may be placed on the outside surface of the bottom overlay 30. For example, the bottom overlay 30 may include printed information consistent with a standard credit card or identification tag, including a name, expiration date and account number. According to another embodiment of the invention, the bottom overlay 30 may be clear or 2/5 clear/white printed. Specifically, a 0.002 inch thick piece of clear PVC material is laminated on to a layer of white PVC that is 0.005 inches in thickness.

A top overlay 40 positioned above the top surface of the printed circuit board 10 is shown in FIG. 1. The top overlay 40 may be comprised of any suitable material, for example, the top overlay 40 may be comprised of polyvinyl chloride (PVC), polyester, acrylonitrile-butadiene-styrene (ABS), polycarbonate, polyethylene terephthalate (PET), PETG, or any other suitable material. Like the bottom overlay 30, the top overlay 40 can be, for example, 0.001 to 0.002 inches thick.

Alternatively, the outside surface of the top overlay 40 may have printed information. For example, the top overlay 40 may include printed information consistent with a standard credit card or identification tag, including a name, expiration date and account number. According to another embodiment of the invention, the top overlay 40 may be clear or “2/5 clear/white printed.”

As previously mentioned, the overall thickness of the electronic card can vary as well as the thickness of the top 102 and bottom 104 cover sheets. In addition to the examples above, other examples can include electronic cards 1 having thicknesses as low as 0.010 inches or lower and as high as 0.200 inches or higher. In addition, the top and bottom cover sheets can have thickness in the range of 0.010 inches to 0.200 inches. Thus, the overall thickness of the electronic card and the thicknesses of the individual parts, such as the top 102 and bottom 104 cover sheets, will depend on the particular application and desired dimensions of the electronic card 1.

As shown in FIG. 1, a core layer 50 is positioned between the top surface of the printed circuit board 10 and the top overlay 40. In addition, as shown in FIG. 1, the core layer 50 is present in an area below the bottom surface 11 of the printed circuit board 10 and above the bottom overlay 30. Preferably, the core layer 50 is composed of a thermosetting polymeric material. For example, the core layer 50 can be composed of polyurea.

Polyurea is a known elastomer that is derived from the reaction product of an isocyanate component and a resin blend component. See What is polyurea? THE POLYUREA DEVELOPMENT ASSOCIATION, at http://www.pda-online.org/pda_resources/whatispoly.asp (last visited Mar. 21, 2007). The isocyanate can be aromatic or aliphatic in nature. Id. It can be monomer, polymer, or any variant reaction of isocyanates, quasi-prepolymer or a prepolymer. Id. The prepolymer, or quasi-prepolymer, can be made of an amine-terminated polymer resin, or a hydroxyl-terminated polymer resin. Id. The resin blend must be made up of amine-terminated polymer resins, and/or amine-terminated chain extenders. Id. The amine-terminated polymer resins will not have any intentional hydroxyl moieties. Id. Any hydroxyls are the result of incomplete conversion to the amine-terminated polymer resins. Id. The resin blend may also contain additives, or non-primary components. Id. These additives may contain hydroxyls, such as pre-dispersed pigments in a polyol carrier. Id. Normally, the resin blend will not contain a catalyst(s). Id.

Polyurea has numerous advantages over other conventional materials currently being used in similar applications. Polyurea has a high resistance to UV light. In addition, polyurea has low elasticity and elongation characteristics. This enables the electronic card 1 to remain rigid. Further, polyurea has high bonding properties, allowing it to effectively bond the top and bottom overlays 40, 30 to the circuit components 20. The circuit components 20 are also held rigidly in place due to the fact that polyurea has a low shrink factor. The electronic card 1 of the present invention also possess desirable environmental characteristics due to polyurea's low moisture absorption and stability at high temperatures.

A method for manufacturing an electronic card according to the present invention will now be described.

First, a printed circuit board 10 is provided. The printed circuit board 10 has a top surface 11 and a bottom surface 12. Circuit traces 14 are present on the top surface 11 of the printed circuit board 10. Alternatively, the printed circuit board 10 may be double-sided having circuit traces 14 on the top surface 11 and the bottom surface 12.

Next, a plurality of circuit components 20 are then positioned onto the printed circuit board 10 and electrically connected to the circuit traces 14 on the top and or bottom surface of the printed circuit board 10. Preferably, as shown in FIG. 2, larger and/or taller circuit components 20 such as the battery 21 are placed in same region along the length of the circuit board 10. This portion of the electronic card 1 will have a larger thickness than other portions of the electronic card 1 with smaller circuit components 20. The circuit components 20 may be connected by any one of several methods including the use of double-sided electrically conducting tape. Preferably, the plurality of circuit components 20 are connected via a conventional soldering process.

Next, the bottom surface 12 of the printed circuit board 10 is affixed to the bottom overlay 30. Preferably, the bottom surface 12 is attached to the bottom overlay 30 using a pressure sensitive adhesive tape or a spray-on adhesive.

The printed circuit board 10, attached to the bottom overlay 30 is then loaded as one complete sheet into an injection molding apparatus. A top overlay 40 is placed into the injection molding apparatus and positioned such that the top overlay 40 is above the top surface 11 of the printed circuit board 10. The injection mold apparatus is preconfigured based on design specifications of the electronic card 1 to manipulate the top overlay 40 so that it conforms to the various thickness of the electronic card 1.

The injection molding apparatus may be a reaction injection molding machine (“which is often individually referred to as “RIM”). These machines are associated with a top mold shell and a bottom mold shell that are capable of performing cold, low pressure, forming operations on at least one of the sheets of polymeric material (e.g., PVC) that make up the top 40 and bottom 30 overlay. Such top and bottom mold shells cooperate in ways that are well known to those skilled in the polymeric material molding arts.

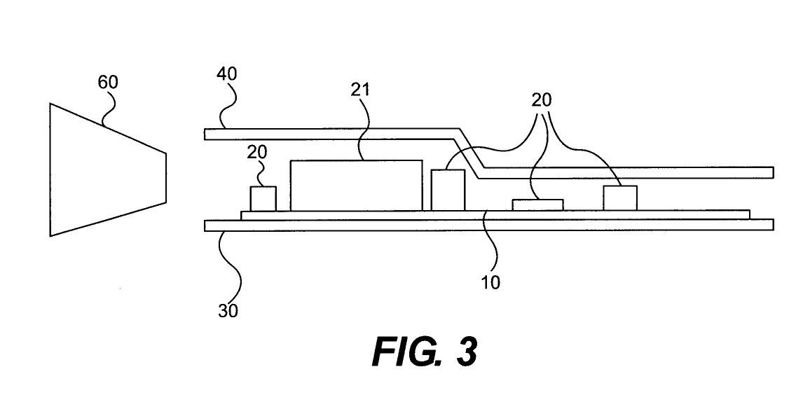

The injection molding apparatus then injects thermosetting polymeric material via a nozzle 60 (shown in FIG. 3) between the top overlay 40 and the bottom overlay 30 forming the core layer 50 from thermosetting polymeric material. Based on the mold, the core layer 50 will be formed at different thicknesses throughout the electronic card 1. For example, as shown in FIG. 1, the thickness of the core layer 50 in the area surrounding the battery 21 is greater than the thickness of the core layer 50 in the area surrounding smaller circuit components. Preferably, as mentioned above, the thermosetting polymeric material is polyurea.

Cold, low pressure forming conditions generally mean forming conditions wherein the temperature of the core layer 50 consisting of thermosetting polymeric material, is less than the heat distortion temperature of the top 40 and bottom 30 overlays, and the pressure is less than about 500 psi. Preferably, the cold forming temperatures will be at least 100° F. less than the heat distortion temperature of the top 40 and bottom 30 overlays. The heat distortion temperature of many polyvinyl chloride (PVC) materials is about 230 degrees F. Thus, the temperatures used to cold form such PVC sheets in the present invention will be no more than about (230° F.−100° F.) 130° F.

According to one embodiment of the invention, the more preferred cold, low pressure forming procedures will involve injection of thermosetting polymeric materials with temperatures ranging from about 56° F. to about 160° F., under pressures that preferably range from about atmospheric pressure to about 500 psi. In another embodiment of the invention, the temperatures of the thermosetting polymeric material being injected into the electronic card 1 will be between about 100° F. and about 120° F. under injection pressures that preferably range from about 80 to 120 psi. In one embodiment of the invention, the liquid or semi-liquid thermosetting polymeric material will be injected under these preferred temperature and pressure conditions at flow rates ranging from about 0.1 to about 70 grams/second. Flow rates of 30 to 50 grams/second are even more preferred.

It should be noted that the use of such relatively cold, low pressure, forming conditions may require that any given gate (i.e., the passageway that connects a runner with each individual device-forming cavity) be larger than those gates used in prior art, hot, high pressure operations. Preferably, the gates are relatively larger than prior art gates so that they are able to quickly pass the thermosetting polymeric material being injected under the cold, low pressure forming conditions. Similarly, the runner (i.e., the main thermosetting polymeric material supply passageway in the mold system that feeds from the source of the thermosetting material to each individual gate), will normally be in a multi-gate or manifold array, and, hence, should be capable of simultaneously supplying the number of gates/device-forming cavities (e.g., 4 to 8 cavities) in the manifold system at the relatively cold temperature (e.g., 56° F. to 160° F.) and relatively low pressure (e.g., atmospheric pressure to 500 psi) conditions used in the process. The flow rates for the polymeric thermosetting material under the low temperature and pressure conditions are able to completely fill a given device-forming cavity in less than or about 10 seconds per device-forming cavity (and more preferably in less than about 3 seconds). Preferably, device-forming cavity fill times of less than 1 second are even more preferred. In view of these conditions, the processes may employ gates having a width that is a major fraction of the length of a leading edge of the device to be formed (that is, a device edge that is connected to a gate). Preferably, the width of a given gate is about 20 percent to about 200 percent of the width of the leading edge (or edges—multiple gates can be used to fill the same device-forming cavity), i.e., the “gated” edge(s), of the embedded electronic being formed.

Preferably, gates are employed that are tapered down from a relatively wide inflow area to a relatively narrow core region that ends at or near the leading edge(s) of the device being formed. Most preferably, these gates will narrow down from a relatively wide diameter (e.g., from about 5 to about 10 mm) injection port that is in fluid connection with the thermosetting material-supplying runner, to a relatively thin diameter (e.g., 0.10 mm) gate/device edge where the gate feeds the thermosetting material into the void space which ultimately becomes the center or core of the finished electronic card 1. Gates that taper from an initial diameter of about 7.0 millimeters down to a minimum diameter of about 0.13 mm will produce especially good results under the preferred cold, low-pressure injection conditions.

Another optional feature that can be used is the use of mold shells that have one or more receptacles for receiving “excess” polymeric material that may be purposely injected into the void space between the top 40 and bottom 30 layers in order to expunge any air and/or other gases (e.g., those gases formed by the exothermic chemical reactions that occur when the ingredients used to formulate most polymeric thermoset materials are mixed together) from said void space. These thermoset ingredients are preferably mixed just prior to (e.g., fractions of a second before) their injection into the void space.

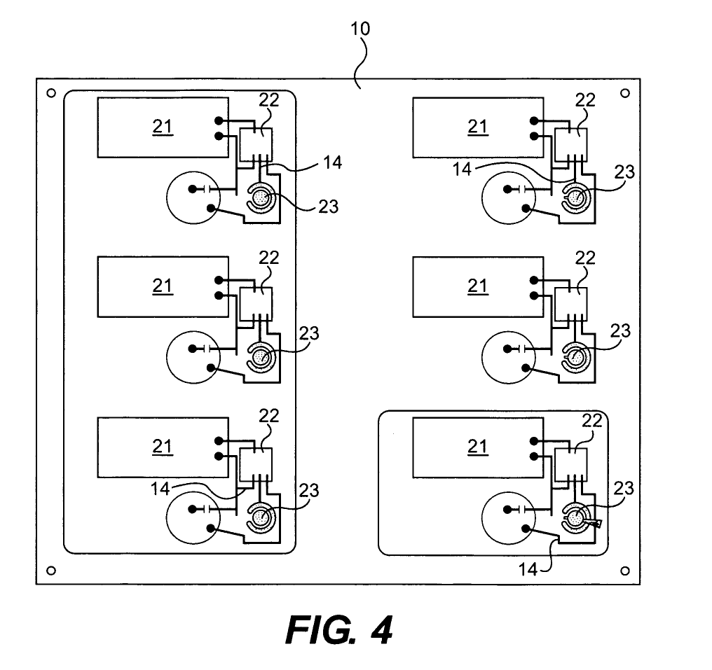

After the injection of the thermosetting polymeric material, the molded structure is then removed from the injection molded apparatus. According to one embodiment of the invention, several electronic cards 1 are cut out of one molded sheet. FIG. 4 depicts several electronic cards 1 formed on one sheet. According to another embodiment of the invention, the injected sheet corresponds to a electronic card 1. The stiffness of the electronic card 1 will depend upon the materials used in the composition of each of the electronic cards 1 individual components.

The finished electronic cards 1 are then removed from the excess polymeric materials (e.g., by trimming them off of the precursor device body) and cut to certain prescribed sizes (e.g., 85.6 mm by 53.98 mm as per ISO Standard 7810) dependent upon the functionality and design parameters of the electronic card 1. The trimming process may also remove the excess material in one cutting/trimming operation. It also will be well appreciated by those skilled in this art that the molding devices used to make such devices in commercial production operations will most preferably have mold shells having multiple cavities (e.g., 2, 4, 6, 8, etc.) for making several such devices simultaneously.

The present invention has several advantages including a cost effective manner to produce one or more electronic cards. The electronic cards are designed to use a greater variety of larger and taller circuit components such as large power sources without significantly increasing the entire size of the electronic card. A portion of the electronic card has physical dimensions that allow the electronic card to remain compatible with most standard applications. In addition, the varying thickness of the electronic card can be used to highlight and display logos, trademarks, or other desirable marketing features.

Further, most of the modules in the electronic card can be constructed in a traditional manner that reduces manufacturing costs. In addition, through the use of polyurea, the method produces a more rigid card or tag that is less likely to have internal stress points that can cause deformation or warping. Moreover, the method of the present invention can be easily adapted to produce multiple electronic cards at once.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

What is claimed is:

1. An electronic card comprising:
a printed circuit board, having a top surface and a bottom surface;
a plurality of circuit components attached to the top surface of the printed circuit board;
a bottom overlay attached to the bottom surface of the printed circuit board;
a top overlay positioned above the top surface of the printed circuit board; and
a core layer positioned between the top surface of the printed circuit board and the top overlay, wherein a first portion of the electronic card has a greater thickness than a second portion of the electronic card.

2. The electronic card of claim 1, wherein the printed circuit board has a plurality of circuit traces on the top surface configured to operably connect to the plurality of circuit components and may have a plurality of circuit traces on the bottom surface configured to operably connect to a plurality of circuit components on the bottom surface of the printed circuit board.

3. The electronic card of claim 1, wherein the first portion of the electronic card is at least twice as thick as the second portion of the electronic card.

4. The electronic card of claim 1, wherein the circuit components positioned in the first portion of the electronic card are greater in height than the circuit components positioned in the second portion of the electronic card.

5. The electronic card of claim 1, wherein a battery is positioned in the first portion of the electronic card.

6. The electronic card of claim 1, wherein the first portion of the electronic card has a thickness in the range of 0.030 to 0.090 inches.

7. The electronic card of claim 1, wherein the second portion of the electronic card has a thickness of 0.030 inches or less.

8. The electronic card of claim 1, wherein the printed circuit board is composed of a flame retardant laminate with woven glass reinforced epoxy resin (FR-4).

9. The electronic card of claim 1, wherein the top and bottom overlay are both comprised of polyvinyl chloride.

10. The electronic card of claim 1, wherein the core layer is comprised of thermosetting polyurea.

11. The electronic card of claim 1, wherein one of the plurality of circuit components includes at least one push button.

12. The electronic card of claim 1, wherein one of the plurality of circuit components includes at least one liquid crystal display.

13. The electronic card of claim 1, wherein one of the plurality of circuit components includes at least one microprocessor chip.

14. The electronic card of claim 1, wherein one of the plurality of circuit components includes at least one speaker.

15. A method for manufacturing an electronic card, comprising:
providing a printed circuit board having a top surface and a bottom surface;
affixing a plurality of circuit components onto the top surface of the printed circuit board;
affixing the bottom surface of the printed circuit board to a bottom overlay using a pressure sensitive adhesive tape or a spray-on adhesive;
loading the printed circuit board and bottom overlay into an injection molding apparatus;
loading a top overlay positioned above a top surface of the printed circuit board into the injection molding apparatus;
injecting thermosetting polymeric material between the top surface of the printed circuit board, the plurality of circuit components and the top overlay such that the first portion of the electronic card has a greater thickness than the second portion of the electronic card.

16. The method of claim 15, wherein the circuit components positioned in the first portion of the electronic card are greater in height than the circuit components positioned in the second portion of the electronic card.

17. The method of claim 15, wherein a battery is arranged in the first portion of the electronic card.

18. The method of claim 15, wherein a plurality of electronic cards are formed on one printed circuit board.

19. The method of claim 15, further comprising:
removing the injected top and bottom overlay from the mold; and
cutting out the plurality electronic cards.

20. The method of claim 15, wherein the circuit traces are formed by etching traces into the printed circuit board.
